(19) United States
(12) Patent Application Publication
(10) Pub. No.: US 2013/0151985 A1
(43) Pub. Date: Jun. 13, 2013

(54) DATA PROCESSING METHOD OF BUSINESS INTELLIGENCE SOFTWARE

(71) Applicants: Jer-Bin Lin, New Taipei City (TW); Chen-Yang Shih, New Taipei City (TW); Po-Tsai Hsieh, New Taipei City (TW); Wei-Ren Juang, Yilan County (TW)

(72) Inventors: Jer-Bin Lin, New Taipei City (TW); Chen-Yang Shih, New Taipei City (TW); Po-Tsai Hsieh, New Taipei City (TW); Wei-Ren Juang, Yilan County (TW)

(21) Appl. No.: 13/401,863

(22) Filed: Feb. 22, 2012

(30) Foreign Application Priority Data
Dec. 8, 2011 (TW) 100145255

(51) Int. Cl. G06F 3/048; G06F 21/20; G06F 17/30

(52) U.S. Cl. 715/748; 726/4

(57) ABSTRACT

A data processing method includes generating statistical data according to data stored in a database; displaying a dialog window on a display screen, the dialog window including at least one block linked to at least one predetermined public address; and selecting the at least one block for uploading the statistical data to the at least one predetermined public address.

### BACKGROUND OF THE INVENTION

1. Field of the Invention

The present invention relates to a data processing method of a business intelligence software, and more particularly, to a data processing method of a business intelligence software capable of uploading statistical data to a predetermined public address rapidly.

2. Description of the Prior Art

For industries of finance, telecom, retail, market research, etc., business intelligence software is a tool for providing important information to a user or a decision maker. The business intelligence software collects data from a database and generates statistical data for a specific purpose by analyzing the data stored in the database according to predetermined logic. The statistical data can be a statistical chart, a statistical table, or a combination of the two. The user can obtain important information on operation of a company or market trends according to the statistical data for further decision making.

As the user performs more complicated queries on the data stored in the database, operating efficiency of the business intelligence software becomes more important. Please refer to FIG. 1. FIG. 1 is a flowchart 100 showing a data processing method of a business intelligence software of the prior art. Firstly, in step 110, business intelligence software links to a database for data analysis. In step 120, a user can set analytical logic for analyzing the data, such as sales trend of a product. Thereafter, in step 130, the business intelligence software generates statistical data by analyzing the data stored in the database according to the analytical logic set by the user. Then in step 140, the user can select an illustration mode to display the statistic data, such as a statistical chart or a statistical table. Finally, in step 150, the user publishes the statistical data at a predetermined public address for allowing other users with particular access authority (such as a manager) to log in to the predetermined public address for browsing contents of the statistical data.

However, in the flowchart of the data processing method of the business intelligence software of the prior art, the step 150 for publishing the statistical data in the predetermined public address is very complicated. For example, after the statistical data is generated, the user needs to write a program for setting a link between the statistical data and the predetermined public address and for setting access authority of the predetermined public address. When the user publishes a plurality of sets of statistical data at a plurality of predetermined public addresses respectively, the user needs to write programs one by one for setting the links and access authority of the plurality of sets of statistical data respectively. The above step of publishing the statistical data of the business intelligence software of the prior art is not only complicated, but also inefficient.

### SUMMARY OF THE INVENTION

The present provides a data processing method of business intelligence software. The method comprises generating statistic data according to data stored in a database; displaying a dialog window on a display screen, the dialog window comprising at least one block linked to at least one predetermined public address; and selecting the at least one block for uploading the statistic data to the at least one predetermined public address.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart showing a data processing method of business intelligence software of the prior art.

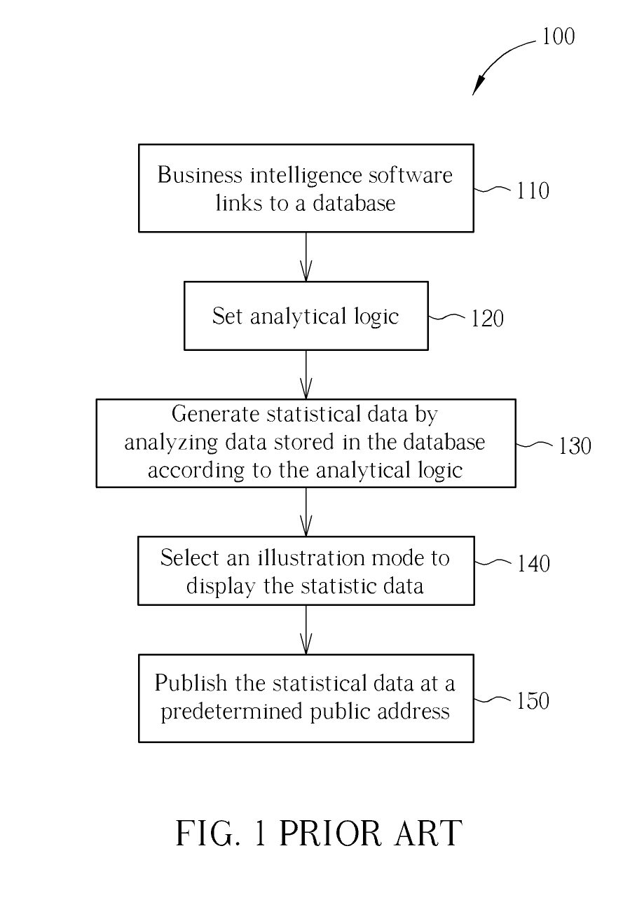

FIG. 2 is a diagram showing a business intelligence software of the present invention performed in a system to process data.

FIG. 3 is a diagram showing a dialog window of the business intelligence software of the present invention.

FIG. 4 is a flowchart showing a data processing method of the business intelligence software of the present invention.

### DETAILED DESCRIPTION

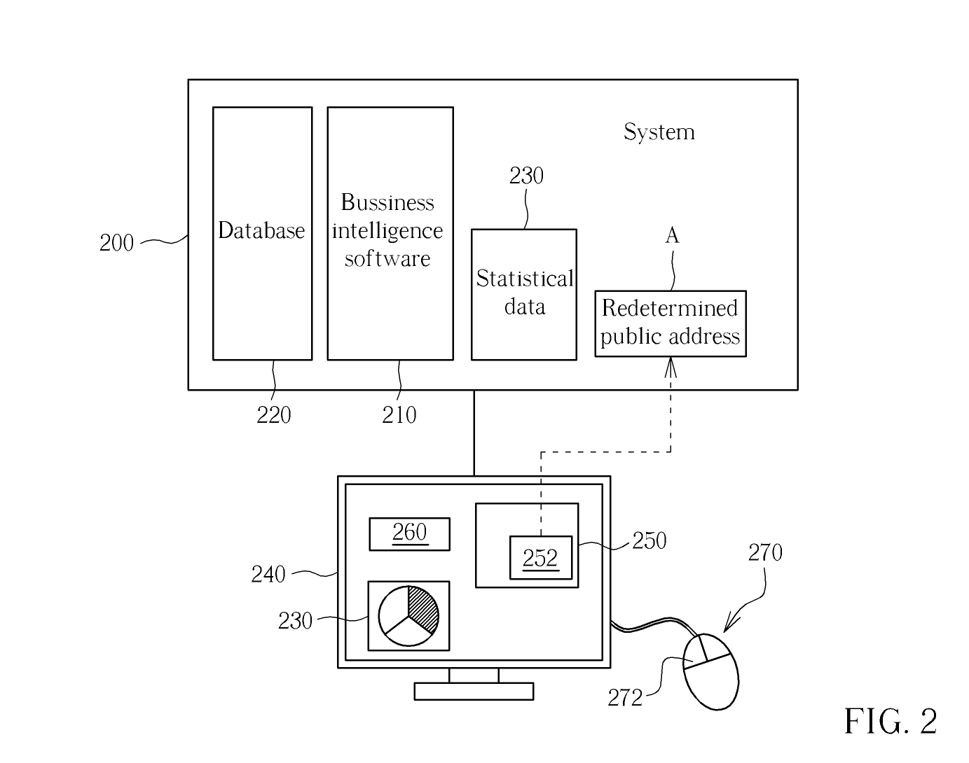

Please refer to FIG. 2. FIG. 2 is a diagram showing business intelligence software 210 of the present invention executed in a system 200 to process data. As shown in FIG. 2, when the business intelligence software 210 generates statistical data 230 by analyzing data stored in a database 220 according to predetermined logic, the business intelligence software 210 of the present invention displays a dialog window 250 on a display screen 240 (the statistical data can be a statistical chart, a statistical table, or a combination of the two for display on the display screen 240). The dialog window 250 comprises at least one block 252, which has been linked to a predetermined public address A in advance. A user can select the block 252 by an input device 270 (such as activating a button 272 of the input device 270) and then upload the statistical data 230 to the predetermined public address A by clicking an uploading hot key 260 via the input device 270 (such as activating a button 272 of the input device 270). When the statistical data 230 is uploaded to the predetermined public address A, the statistical data 230 is published at the predetermined public address A. In addition, access authority of the predetermined public address A can be determined in advance for allowing users with particular access authority (such as a manager) to browse the statistical data 230. In the above procedures, a link between the dialog window 250 and the predetermined public address A and the access authority of the predetermined public address A are preset. Therefore, the user does not need to write a program for setting the link between the statistical data and the predetermined public address and the access authority of the predetermined public address respectively after the statistical data is generated.

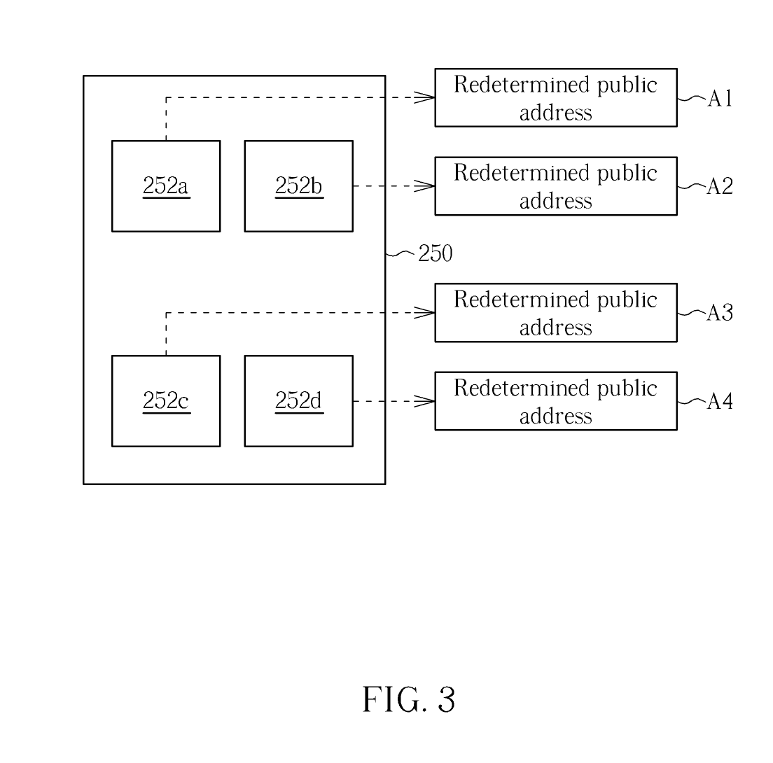

Please refer to FIG. 3 and refer to FIG. 2 as well. FIG. 3 is a diagram showing the dialog window 250 of the business intelligence software 210 of the present invention. The dialog window 250 of the business intelligence software 210 of the present invention can comprise a plurality of blocks 252. Each block 252 is linked to a predetermined public address A. Before the dialog window 250 is generated, the business intelligence software 210 allows the user to set a quantity of blocks in the dialog window 250 and to set the respective predetermined public addresses corresponding to the blocks in the dialog window 250. For example, a block 252a corresponds to a predetermined public address A1, a block 252b corresponds to a predetermined public address A2, a block 252c corresponds to a predetermined public address A3, and a block 252d corresponds to a predetermined public address A4. When the quantity of the blocks in the dialog window 250 and the predetermined public addresses corresponding to the blocks 252 are determined, the business intelligence software 210 displays the dialog window 250 with a plurality of blocks on the display screen 240 after a plurality of sets of statistical data is generated. And, the user can select the block 252 in the dialog window 250 for uploading the plurality of sets of statistical data to the predetermined public addresses A respectively, and the plurality of sets of statistical data can be published at the corresponding predetermined public addresses A. In addition, the access authority of each predetermined public address A can be determined in advance for allowing users with particular access authority (such as a manager) to browse the statistical data in the predetermined public address. Therefore, the dialog window 250 of the business intelligence software 210 of the present invention provides a public platform for uploading and publishing the plurality of sets of statistical data to corresponding predetermined public addresses A via the blocks 252 in the dialog window 250 respectively. The user does not need to write programs one by one for setting the links and access authority of the plurality of sets of statistical data respectively after the plurality of sets of statistical data is generated.

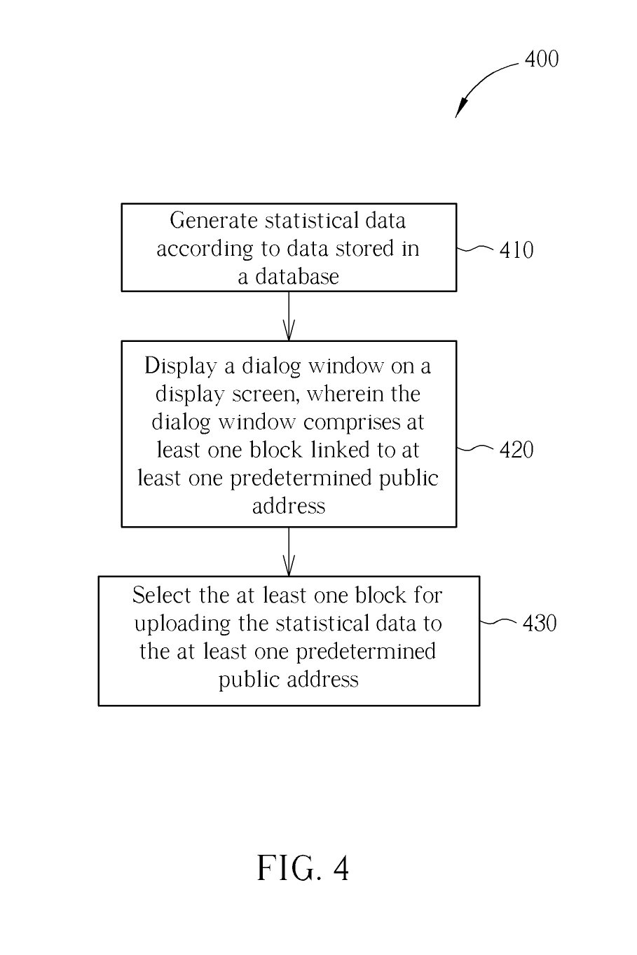

Please refer to FIG. 4. FIG. 4 is a flowchart showing a data processing method of the business intelligence software of the present invention. The data processing method of the business intelligence software of the present invention comprises the following steps:

Step 410: Generate statistical data according to data stored in a database;

Step 420: Display a dialog window on a display screen, wherein the dialog window comprises at least one block linked to at least one predetermined public address; and

Step 430: Select the at least one block for uploading the statistical data to the at least one predetermined public address.

Summarizing the above, the data processing method of the business intelligence software of the present invention significantly simplifies the step of publishing the statistical data at the predetermined public address. The user can select the block corresponding to the statistical data by an input device (such as activating a button of the input device) and upload the statistical data to the predetermined public address instantly.

In contrast to the prior art, the business intelligence software of the present invention simplifies the step of publishing the statistical data by providing a preset dialog window. Furthermore, the plurality of sets of statistical data can be uploaded and published at the corresponding predetermined public addresses via the dialog window respectively. The method of the present invention not only simplifies the step of publishing the statistical data, but also increases efficiency of the business intelligence software.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data processing method of business intelligence software, comprising:
generating statistical data according to data stored in a database;
displaying a dialog window on a display screen, wherein the dialog window comprises at least one block linked to at least one predetermined public address; and
selecting the at least one block for uploading the statistical data to the at least one predetermined public address.

2. The method of claim 1, further comprising publishing the statistical data in the at least one predetermined public address.

3. The method of claim 1, further comprising setting access authority of the at least one predetermined public address.

4. The method of claim 1, wherein the statistical data is a statistical chart, a statistical table, or a combination of the statistical chart and the statistical table.

5. The method of claim 1, wherein the dialog window comprises a plurality of blocks, and each block is linked to a corresponding predetermined public address.

6. The method of claim 1, further comprising setting a quantity of blocks in the dialog window.

7. The method of claim 6, further comprising setting the blocks in the dialog window to correspond to respective predetermined public addresses.

8. The method of claim 1, wherein generating the statistical data according to the data stored in the database comprises generating the statistical data by analyzing the data stored in the database according to predetermined logic.

9. The method of claim 1, wherein selecting the at least one block for uploading the statistical data to the at least one predetermined public address is clicking a button to select the at least one block for uploading the statistical data to the at least one predetermined public address.
